(19) United States
(12) Patent Application Publication
(10) Pub. No.: US 2016/0078016 A1
(43) Pub. Date: Mar. 17, 2016

(54) INTELLIGENT ONTOLOGY UPDATE TOOL

(71) Applicant: GENERAL ELECTRIC COMPANY, SCHENECTADY, NY (US)

(72) Inventors: LUIS BABAJI NG TARI, NISKAYUNA, NY (US); ALEXANDRE NIKOLOV IANKOULSKI, NISKAYUNA, NY (US); TIANYI WANG, NISKAYUNA, NY (US)

(73) Assignee: GENERAL ELECTRIC COMPANY, SCHENECTADY, NY (US)

(21) Appl. No.: 14/484,380

(22) Filed: Sep. 12, 2014

(51) Int. Cl. G06F 17/27; G06F 17/30

(52) U.S. Cl. CPC G06F 17/277; G06F 17/30734; G06F 17/3053

(57) ABSTRACT

Systems, methods and computer program products to automate the process of ontology updates in radiology software are provided. In one aspect, the present disclosure analyzes the textual data describing the radiology exams and identifies terms that are not defined in the existing ontology. It then extracts various types of statistical patterns, such as neighboring concepts, from the textual data, and infers which concepts the unrecognized terms belong to. Finally it presents rank-ordered ontology updating suggestions to the user for final confirmation. The system, methods, and computer program products of the present disclosure are an effective way in updating ontologies, requiring the users to have little, or no prior experience in ontology management or understanding of the underlying ontology structure.

### FIELD OF DISCLOSURE

The present disclosure relates to healthcare terminology mapping, and more particularly to systems, methods and computer program products for automating the process of updating ontologies in radiology software.

### BACKGROUND

The statements in this section merely provide background information related to the disclosure and may not constitute prior art.

Ontologies have become an important part in understanding the semantics of textual content for healthcare and medical software applications. Ontologies are heavily used in analyzing unstructured, descriptive textual data. Such data is usually free-form text from manual inputs, such as series descriptions and study descriptions in radiology exams. One of the challenges in managing medical ontologies is the need to capture variation of terms that can be specific to hospital sites or even users. On one hand, new variations can emerge over time during the life cycle of the application; on the other hand, many medical terms have strong site conventions and thus it is difficult for the ontology accompanying the product release to cover all site-specific terms. For example, the term “pelvis”, one of the body parts, may be abbreviated as “pel” in some sites. The performance of a healthcare and medical software application that relies on ontologies can suffer when some of the terms encountered are not captured in the ontology. Therefore, ontologies need to be timely updated in order for the application to perform. For medical applications, it is important to update the ontology within the environment where it is being used so that site specific conventions can be captured.

An ontology defines a set of terms and how they relate to each other, and sometimes can be represented in the form of hierarchies. Ontology update is typically a manual process in which an ontology editor is used to review and edit the ontology. This requires the user to have a good understanding of the underlying structure of the ontology as well as the existing terms already defined in order to add new terms to the appropriate ontology hierarchy. In addition, the process of manually updating ontologies can be time-consuming and error-prone. Erroneous ontology entries can have a negative impact on application performance. A manual updating approach is thus difficult to be adopted and followed by the end users.

### BRIEF SUMMARY

In view of the above, there is a need for systems, methods, and computer program products which can automate the process of ontology update, so that in the presence of terms that cannot be recognized by the ontology, the process can still make a prediction of the unrecognized terms and provide suggestions to update the ontology. The above-mentioned needs are addressed by the subject matter disclosed herein.

According to one aspect of the present disclosure, a system that allows the automation of ontology updates by: 1) analyzing the textual data describing, for example, a radiology exam; 2) identifying terms that are not defined in the existing ontology; 3) extracting statistical patterns from the textual data and inferring which concepts the unrecognized terms belong to, and 4) presenting rank-ordered ontology updating suggestions, is provided.

According to another aspect of the present disclosure, a method that allows the automation of ontology updates by: 1) analyzing the textual data describing the radiology exams; 2) identifying terms that are not defined in the existing ontology; 3) extracting statistical patterns from the textual data and inferring which concepts the unrecognized terms belong to, and 4) presenting rank-ordered ontology updating suggestions, is provided.

This summary briefly describes aspects of the subject matter disclosed below in the Detailed Description section, and is not intended to be used to limit the scope of the subject matter described in the present disclosure.

### BRIEF DESCRIPTION OF THE DRAWINGS

The features and technical aspects of the system and method disclosed herein will become apparent in the following Detailed Description set forth below when taken in conjunction with the drawings in which like reference numerals indicate identical or functionally similar elements.

FIG. 1 is a block diagram of an example intelligent ontology update tool system according to one aspect of the present disclosure.

FIG. 2 is a flow diagram illustrating an example method of the intelligent ontology update tool operating the system of FIG. 1, according to one aspect of the present disclosure.

FIG. 3 is a flow diagram illustrating implementing an example method of operating the system of FIG. 1, according to one aspect of the present disclosure.

FIG. 4 is a block diagram of an example processor system that can be used to implement the systems and methods described herein according to one aspect of the present disclosure.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

### I. OVERVIEW

Certain examples provide an Intelligent Ontology Update Tool. The Intelligent Ontology Update Tool is a statistical learning tool and system that automates the process of ontology update in radiology-related healthcare and medical software, where ontologies are used to understand the meaning of medical terms and their variations that appear in the textual descriptions of radiology exams. Variations of those terms can be specific to particular hospital sites, and thus ontologies are typically customized at the site level in order to ensure the performance of the ontology-dependent application. Therefore it is desirable to have a tool that end users, rather than the developers, may utilize to customize ontologies so that those site-specific term variations can be easily captured at user side. The Intelligent Ontology Update Tool meets such a need. The Intelligent Ontology Update Tool analyzes the textual data describing the radiology exams and identifies terms that are not defined in the existing ontology. It then extracts statistical patterns, such as neighboring concepts, from the textual data, and infers which concepts to which the unrecognized terms belong. Finally it presents rank-ordered ontology updating suggestions to the user for final confirmation. The Intelligent Ontology Update Tool can be an effective way in updating ontologies, requiring the users to have little (or no) prior experience in ontology management, understanding of the underlying ontology structure, or programming experience.

Other aspects, such as those discussed below and others as will be appreciated by one having ordinary skill in the art upon reading the enclosed description, are also possible.

### II. EXAMPLE SYSTEM

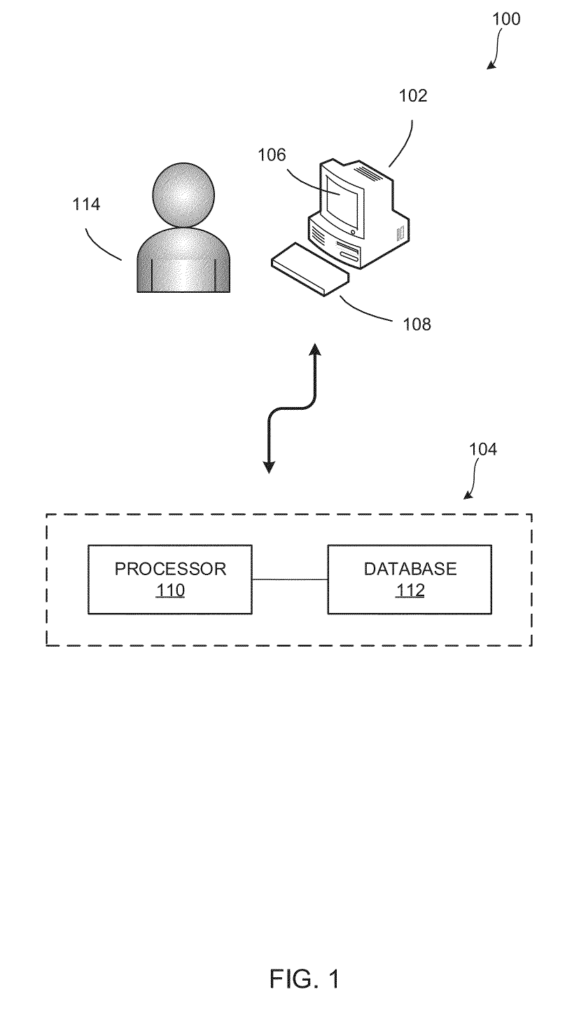

FIG. 1 depicts an example system 100 for updating ontologies, according to one aspect of the present disclosure. System 100 includes a computer 102 and an ontology updater 104 communicatively coupled to computer 102. In this example, computer 102 includes a user interface 106 and a data input (e.g., a keyboard, mouse, microphone, etc.) 108 and ontology updater 104 includes a processor 110 and a database 112.

In certain aspects, user interface 106 displays data such as text samples, which may include, for example, data from text files, DICOM files, database records, or metadata from other applications, which are received from annotator 104. In certain aspects, user interface 106 receives commands and/or input from a user 114 via data input 108. In aspects where system 100 is used to review generated ontology update suggestions, user interface 106 displays the generated suggestions together with context information such as where the unrecognized terms were seen and where they are ranked according to the number of occurrences in the data collection. User 114 can then decide to accept, ignore, or modify-accept the suggestions to the oncology, for example. In certain aspects, user 114 can modify the form of the unrecognized terms, or choose other concept and/or synonym that the term should belong to, before accepting the new ontology term.

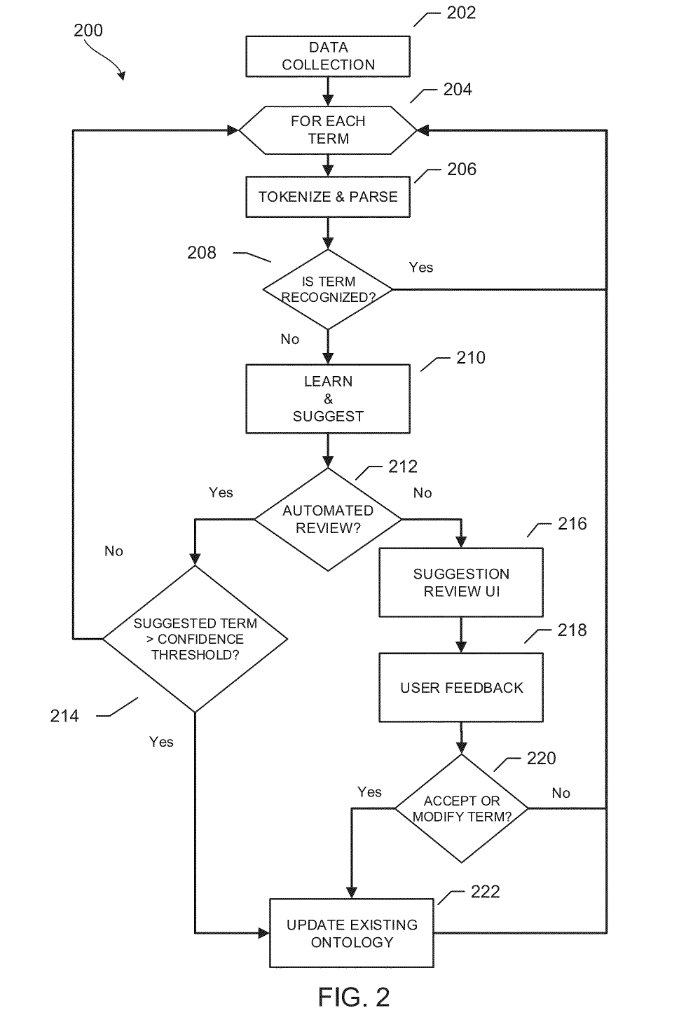

FIG. 2 illustrates a flow diagram of ontology updater 104 according to one aspect of the present disclosure. Ontology updater 104 collects a batch of text samples of one target text field from the existing IT infrastructure of the site 202. The data may come from text files, DICOM files, database records, or metadata from other applications, for example. For each term (block 204) ontology updater 104 performs a training phase, testing phase, and suggesting phase. At block 206, ontology updater 104 applies a training phase in which a collection of textual data from the targeted fields is tokenized and parsed through dictionary matching using the existing ontology. For example, ‘MRI’ in the study description is mapped to the concept <Modality>, while ‘SAG’ is mapped to the concept <Orientation>. With the annotated text fields, ontology updater 104 collects and identifies statistical patterns of recognized ontology terms from the data. This term identification step reveals the concepts to which the terms belong. The terms that are not matched are treated as unrecognized terms. In addition to using typical tokenization methods that handle different languages, a technique is used to identify contiguous tokens that should be treated as a single token rather than individual tokens: Tokens tᵢ and tᵢ₊₁ are treated as a single token if the frequency of tᵢ equals to the frequency of tᵢ together with tⱼ among all text fields. For example, the tokens ‘tibia’ and ‘fibula’ appear frequently together such that the frequency of ‘tibia’ is the same as the frequency of the bi-gram ‘tibia fibula’. In this example, ‘tibia fibula’ is treated as one token.

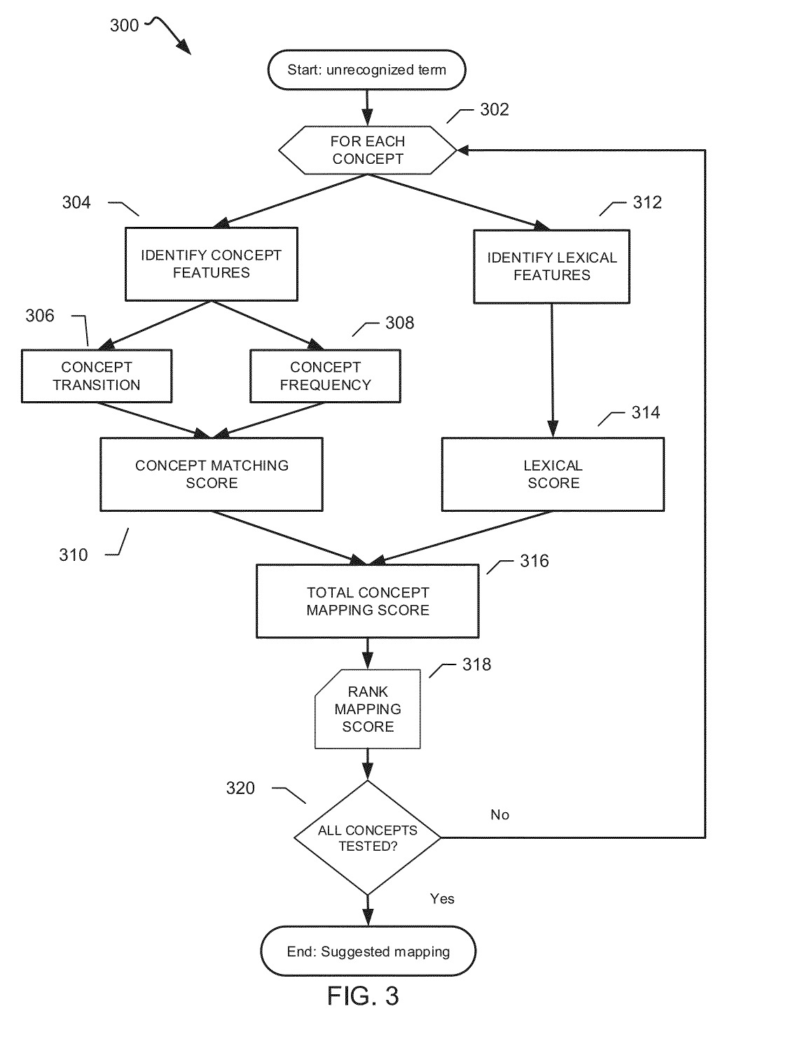

If the term is recognized (block 208), the ontology updater 104 continues with the next term (block 204). If the term is unrecognized, the ontology updater 104 performs the Learn & Suggest step 210 using the ontology suggestion process 300 (explained below with reference to FIG. 3) to make suggestions on selected unrecognized terms that should be considered for addition into the existing ontology. In certain aspects, if user 114 had pre-determined to automate the review (block 212), the suggested term is then compared to a pre-determined probability/confidence level (block 214). If the suggested term is greater than the confidence threshold 214, the existing ontology is updated with the suggested term (block 222). If the suggested term is less than or equal to the pre-determined confidence level (block 214) then the existing ontology is not updated with the suggested term and the next unrecognized term is evaluated (block 204). Once all the unrecognized terms have been examined, the ontology updater 104 is complete.

If user 114 had elected to review each unrecognized term, the generated suggestions are displayed on user interface 106 together with context information such as where the unrecognized terms were seen, where that are ranked according to the number of occurrences in the data collection and the probability/confidence of the suggestion in step 216. The context information assists the user in making decisions about the generated suggestions.

User 114 provides feedback 218 and can modify the form of the unrecognized terms, or choose other concept and/or synonym that the term should belong to, before accepting the new ontology term, for example (step 220). The user-accepted ontology terms are merged into the existing ontology 222, ready to be used in a new round of ontology suggestions and updating. If the user chooses not to accept or modify the suggested term (block 220), the user examines the next suggestion for each remaining unrecognized term until all the unrecognized terms have been evaluated.

### III. EXAMPLE METHOD

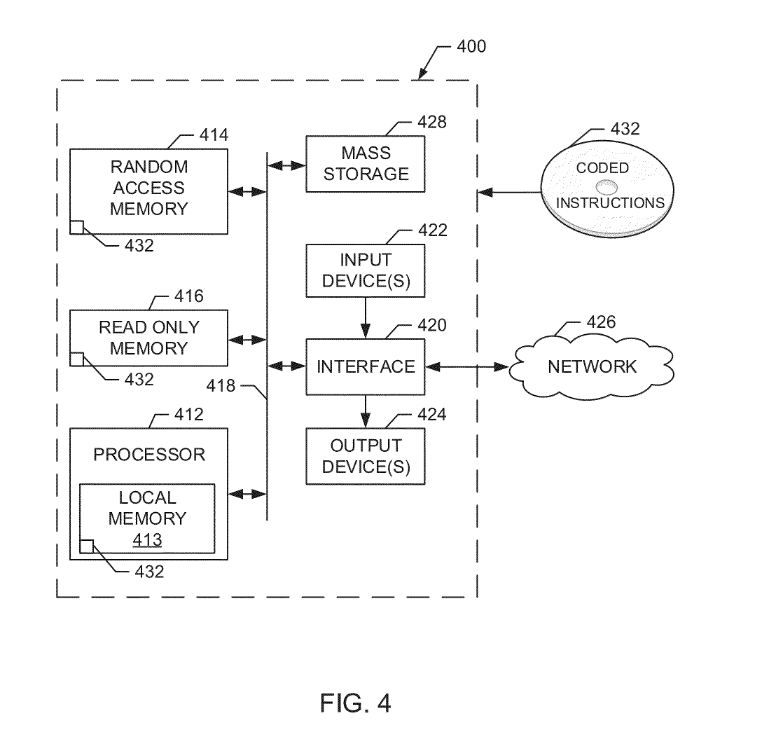

A flowchart representative of example machine readable instructions for implementing the ontology updating process 300 of the example system 100 is shown in FIG. 3. In these examples, the machine readable instructions comprise a program for execution by a processor such as processor 412 shown in the example processor platform 400 discussed below in connection with FIG. 4. The program can be embodied in software stored on a tangible computer readable storage medium such as a CD-ROM, a floppy disk, a hard drive, a digital versatile disk (DVD), a BLU-RAY™ disk, or a memory associated with processor 412, but the entire program and/or parts thereof could alternatively be executed by a device other than processor 412 and/or embodied in firmware or dedicated hardware. Further, although the example program is described with reference to the flowchart illustrated in FIG. 3, many other methods of implementing the example annotator can alternatively be used. For example, the order of execution of the blocks can be changed, and/or some of the blocks described can be changed, eliminated, or combined.

As mentioned above, process 300 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably.

Additionally or alternatively, process 300 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

Process 300 begins with an unrecognized term from the ontology updater 104, where computer 102 receives, via data input 108, initial input of text samples of a targeted text field at user interface 106 and/or stored in database 112. In certain aspects of the present disclosure, the target text field can be the study description or the series description, for example.

For each concept under examination (block 302) an implementation of the Bayes theorem is used to compute and learn the statistical patterns, which are derived from several features among the collection of text fields, collectively categorized as concept features (block 304) and lexical features (block 312) and are described below.

Concept features 304 include two components: concept transition (block 306) and concept frequency (block 308). Concept transition 306 refers to the translation probabilities from one concept to another. For example, the likelihood of observing a term belonging to the concept <Modality> given that the following term belongs to the concept <BodyPart>. Concept frequency 308 is defined as the number of times a concept appears in a text field.

Given a text field with n tokens (denoted as T) and concepts (denoted as C). Let tᵢ be the target unrecognized token in the i-th position among the sequence of tokens in T. The likelihood of tᵢ belonging to a concept cⱼ is computed based on concept transition (denoted as P_{ct}(tᵢ=cⱼ)) and concept frequency (denoted as P_{cf}(tᵢ=cⱼ)). P_{ct}(tᵢ=cⱼ) is defined as the probability of token tᵢ assigned to cⱼ given the concept assignment for the other tokens. This is computed based on the neighboring tokens by means of conditional probabilities, i.e., P(tᵢ=cⱼ|t₁=cₖ, . . . tₙ=cₖ′) Using the Bayes theorem P(t|X)=P(X|t)·P(t)/P(X), P_{ct}(tᵢ=cⱼ) is formulated as follows:

P(tᵢ=cⱼ|t₁=cₖ, . . . ,tₙ=c_{k′})=P(t₁=cₖ, . . . tₙ=c_{k′}|tᵢ=cⱼ)·P(tᵢ=cⱼ)/P(t₁=cₖ, . . . ,tₙ=C_{k′}) Equation 1

By applying the independence assumption, P_{ct}(tᵢ=cⱼ) is further formulated as follows:

P(tᵢ=cⱼ|t₁=cₖ, . . . tₙ=c_{k′})=P(t₁=cₖ|tᵢ=cⱼ)· . . . ·P(tₙ=c_{k′}|tᵢ=cⱼ)·P(tᵢ=cⱼ)/P(t₁=Cₖ, . . . ,tₙ=c_{k′}) Equation 2

P(xᵢ|t) is the number of times that xᵢ occurs with t divided by the number of occurrences of t. Since P(t₁=cₖ, . . . tₙ=c_{k′}) is the same for all instances, it is a constant normalization factor that can be ignored without affecting the algorithm.

The concept frequency feature P_{cf}(t=c) is defined as the probability of term t belonging to concept c based on the number of occurrences of c in each text field. The assumption is that a token assigned to a particular concept in a text field should have a similar distribution of concepts as other text fields in the dataset. For instance, the concept <Modality> typically appears once among the text fields for study description. Suppose a text field already contains a term that belongs to the <Modality> concept, there should be a low chance for the unrecognized term to belong to the <Modality> concept for that text field.

At block 312, Lexical features are derived using string matching. Approximate string matching enables the identification of closely matching words, and this is ideal for realizing the meaning behind the acronyms used in radiology exams. For instance, “ABD” is frequently used as an acronym for “abdomen”. Here two approximate string matching metrics are candidates to compute string similarity: longest common substring and longest common prefix. Longest common substring is defined as the longest substring that is shared between a pair of strings, and longest common prefix is defined as the longest substring that is shared between a pair of strings and the substring appears at the beginning for both strings. This string is referred to as the longest common string. Another popular approximate string matching metric is Levenshtein distance. However, it is observed that the use of Levenshtein distance does not work well in matching terms with short length, which frequently occurs in textual descriptions of radiology exams.

In the present disclosure, string similarity between two strings s₁ and s₂, denoted as strSim(s₁, S₂), is computed based on the longest common string, denoted as lcstr, between s₁ and s₂. Thus, strSim(s₁, s₂) is defined as: Equation 3: strSim(s₁, s₂)=(length(s₁)−length(lcstr))+(length(s₂)−length(lcstr))

A score of 0 is assigned if s₁ and S₂ are identical. Otherwise, the higher the score, the greater the degree of dissimilarity between S₁ and S₂.

A concept matching score (block 310) is the likelihood of a term t to be mapped to concept c based on concept transition and concept frequencies, and it is denoted as score_{concept}(t=c). The concept matching score is defined as the sum weighted probabilities of concept transition and concept frequencies:

score_{concept}(t=c)=(w·P_{ct}(t=c)+(1−w)·P_{cf}(t=c))·p^{y} Equation 4

A suggestion is penalized, denoted as p, if the text field includes y number of unrecognized terms, where p is a value that ranges between 0 and 1.

The lexical score (block 314) is the likelihood of a term t belonging to concept c based on string similarity. It is computed by finding the closest string similarity match among t and the sub-concepts of c: score_{lexical}(t=c)=argmin strSim(t, cₖ)

At block 316, ontology updater 104 tests the targeted text field data against the existing ontology and identifies terms that are not defined in the existing ontology by applying the learned model to the same input text fields and computes the concept mapping scores for each unrecognized term based on the concept and lexical features. Thus, the concept mapping score (block 316) is a sum of the weighted scores of concept matching and lexical scores.

Ontology updater 104 computes the likelihood (confidence score) of each unrecognized term belonging to a certain defined concept in the ontology and prepares a list of inferred ontology mappings. At block 318, ontology updater 104 creates the individual ontology mappings and generates a list of ontology suggestions ranked by their overall importance for updating. For example, the suggestions may be ranked first based on the number of times that an unrecognized term appears in the whole data set, and second on the probability/confidence of the suggestions. The unrecognized term t is suggested to map to a concept that results in the highest concept mapping score.

### IV. COMPUTING DEVICE

The subject matter of this description may be implemented as stand-alone system or for execution as an application capable of execution by one or more computing devices 102. The application (e.g., webpage, downloadable applet or other mobile executable) can generate the various displays or graphic/visual representations described herein as graphic user interfaces (GUIs) or other visual illustrations, which may be generated as webpages or the like, in a manner to facilitate interfacing (receiving input/instructions, generating graphic illustrations) with users via the computing device(s).

Memory and processor 110 as referred to herein can be stand-alone or integrally constructed as part of various programmable devices, including for example a desktop computer, tablet, mobile device or laptop computer hard-drive, field-programmable gate arrays (FPGAs), application-specific integrated circuits (ASICs), application-specific standard products (ASSPs), system-on-a-chip systems (SOCs), programmable logic devices (PLDs), etc. or the like or as part of a Computing Device, and any combination thereof operable to execute the instructions associated with implementing the method of the subject matter described herein.

Computing device as referenced herein may include: a mobile telephone; a computer such as a desktop or laptop type; a Personal Digital Assistant (PDA) or mobile phone; a notebook, tablet or other mobile computing device; or the like and any combination thereof.

Computer readable storage medium or computer program product as referenced herein is tangible (and alternatively as non-transitory, defined above) and may include volatile and non-volatile, removable and non-removable media for storage of electronic-formatted information such as computer readable program instructions or modules of instructions, data, etc. that may be stand-alone or as part of a computing device. Examples of computer readable storage medium or computer program products may include, but are not limited to, RAM, ROM, EEPROM, Flash memory, CD-ROM, DVD-ROM or other optical storage, magnetic cassettes, magnetic tape, magnetic disk storage or other magnetic storage devices, or any other medium which can be used to store the desired electronic format of information and which can be accessed by the processor or at least a portion of the computing device.

The terms module and component as referenced herein generally represent program code or instructions that causes specified tasks when executed on a processor. The program code can be stored in one or more computer readable mediums.

Network as referenced herein may include, but is not limited to, a wide area network (WAN); a local area network (LAN); the Internet; wired or wireless (e.g., optical, Bluetooth, radio frequency (RF)) network; a cloud-based computing infrastructure of computers, routers, servers, gateways, etc.; or any combination thereof associated therewith that allows the system or portion thereof to communicate with one or more computing devices.

The term user and/or the plural form of this term is used to generally refer to those persons capable of accessing, using, or benefiting from the present disclosure.

FIG. 4 is a block diagram of an example processor platform 400 capable of executing process 300 for updating ontologies. Processor platform 400 may be, for example, a server, a personal computer, a mobile device (e.g., a cell phone, a smart phone, a tablet such as an IPAD™), a personal digital assistant (PDA), an Internet appliance, or any other type of computing device.

Processor platform 400 includes a processor 412. Processor 412 of the illustrated example is hardware. For example, processor 412 may be implemented by one or more integrated circuits, logic circuits, microprocessors or controllers from any desired family or manufacturer.

Processor 412 includes a local memory 413 (e.g., a cache). Processor 412 of the illustrated example is in communication with a main memory including a volatile memory 414 and a non-volatile memory 416 via a bus 418. Volatile memory 414 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 416 can be implemented by flash memory and/or any other desired type of memory device. Access to main memory 414, 416 is controlled by a memory controller.

Processor platform 400 also includes an interface circuit 420. Interface circuit 420 can be implemented by any type of interface standard, such as an Ethernet interface, a universal serial bus (USB), and/or a PCI express interface.

One or more input devices 422 are connected to the interface circuit 420. Input device(s) 422 permit(s) a user to enter data and commands into processor 412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to interface circuit 420 of the illustrated example. Output devices 424 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). Interface circuit 420 of the illustrated example, thus, typically includes a graphics driver card, a graphics driver chip or a graphics driver processor.

Interface circuit 420 of the illustrated example also includes a communication device such as a transmitter, a receiver, a transceiver, a modem and/or network interface card to facilitate exchange of data with external machines (e.g., computing devices of any kind) via a network 426 (e.g., an Ethernet connection, a digital subscriber line (DSL), a telephone line, coaxial cable, a cellular telephone system, etc.).

Processor platform 400 of the illustrated example also includes one or more mass storage devices 428 for storing software and/or data. Examples of such mass storage devices 428 include floppy disk drives, hard drive disks, compact disk drives, Blu-ray disk drives, RAID systems, and digital versatile disk (DVD) drives.

Coded instructions 432 may be stored in mass storage device 428, in volatile memory 414, in the non-volatile memory 416, and/or on a removable tangible computer readable storage medium such as a CD or DVD.

### VI. CONCLUSION

This written description uses examples to disclose the subject matter, and to enable one skilled in the art to make and use the invention. The above disclosed methods and apparatus disclosed and described herein enable the automation of updating ontologies. From the foregoing, it will be appreciated that the above disclosed methods and apparatus provide an effective way in updating ontologies, requiring users to have little (or no) prior experience in ontology management, understanding of the underlying ontology structure, or programming experience. The patentable scope of the subject matter is defined by the following claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method to automate the process of ontology update, the method comprising:
loading reference data comprising prior mapped ontology;
receiving, parsing, and tokenizing text data;
generating a set of recognized and a set of unrecognized terms by matching said text data to said ontology;
classifying each unrecognized term of said set of unrecognized terms by identifying concept features and generating an associated concept matching score;
classifying each unrecognized term of said set of unrecognized terms by identifying lexical features and generating an associated lexical score;
generating for each unrecognized term of said set of unrecognized terms a total concept mapping score by summing said concept matching score and said lexical score;
mapping each unrecognized term of said set of unrecognized terms to a concept that results in the highest total concept mapping score;
updating the ontology based on said concept mapping.

2. The computer-implemented method of claim 1, wherein the method further comprises:
computing the likelihood (confidence value) of each unrecognized term belonging to a certain defined concept in the ontology.

3. The computer-implemented method of claim 2, wherein the method further comprises:
updating the ontology automatically based on a pre-defined confidence value.

4. The computer-implemented method of claim 1, wherein the method further comprises:
generating a list of ontology suggestions ranked by their overall importance for updating.

5. The computer-implemented method of claim 4, wherein the method further comprises:
displaying said list of generated ontology suggestions and updating the ontology after a user confirms the mapping.

6. The computer-implemented method of claim 4, wherein the method further comprises:
displaying said list of generated ontology suggestions and allowing the user to modify the mapping prior to updating the ontology.

7. A computer storage device including program instructions for execution by a computing device to perform:
loading reference data comprising prior mapped ontology;
receiving, parsing, and tokenizing text data;
generating a set of recognized and a set of unrecognized terms by matching said text data to said ontology;
classifying each unrecognized term of said set of unrecognized terms by identifying concept features and generating an associated concept matching score;
classifying each unrecognized term of said set of unrecognized terms by identifying lexical features and generating an associated lexical score;
generating for each unrecognized term of said set of unrecognized terms a total concept mapping score by summing said concept matching score and said lexical score;
mapping each unrecognized term of said set of unrecognized terms to a concept that results in the highest total concept mapping score;
updating the ontology based on said concept mapping.

8. The computer storage device of claim 7, further including program instructions for execution by said computing device to perform:
computing the likelihood (confidence value) of each unrecognized term belonging to a certain defined concept in the ontology.

9. The computer storage device of claim 8, further including program instructions for execution by said computing device to perform:
updating the ontology automatically based on a pre-defined confidence value.

10. The computer storage device of claim 7, further including program instructions for execution by said computing device to perform:
generating a list of ontology suggestions ranked by their overall importance for updating.

11. The computer storage device of claim 10, further including program instructions for execution by said computing device to perform:
displaying said list of generated ontology suggestions and updating the ontology after a user confirms the mapping.

12. The computer storage device of claim 10, further including program instructions for execution by said computing device to perform:
displaying said list of generated ontology suggestions and allowing the user to modify the mapping prior to updating the ontology.

13. A system comprising a processor, the processor configured to execute computer program instructions to:
load reference data comprising prior mapped ontology;
receive, parse, and tokenize text data;
generate a set of recognized and a set of unrecognized terms by matching said text data to said ontology;
classify each unrecognized term of said set of unrecognized terms by identifying concept features and generating an associated concept matching score;
classify each unrecognized term of said set of unrecognized terms by identifying lexical features and generating an associated lexical score;
generate for each unrecognized term of said set of unrecognized terms a total concept mapping score by summing said concept matching score and said lexical score;
map each unrecognized term of said set of unrecognized terms to a concept that results in the highest total concept mapping score;
update the ontology based on said concept mapping.

14. The system of claim 13, wherein the system further comprises:
computing the likelihood (confidence value) of each unrecognized term belonging to a certain defined concept in the ontology.

15. The system of claim 14, wherein the system further comprises: updating the ontology automatically based on a pre-defined confidence value.

16. The system of claim 13, wherein the system further comprises:
generating a list of ontology suggestions ranked by their overall importance for updating.

17. The system of claim 16, wherein the system further comprises:
displaying said list of generated ontology suggestions and updating the ontology after a user confirms the mapping.

18. The system of claim 16, wherein the system further comprises:
displaying said list of generated ontology suggestions and allowing the user to modify the mapping prior to updating the ontology.
